(19) United States
(12) Patent Application Publication
(10) Pub. No.: US 2012/0181115 A1
(43) Pub. Date: Jul. 19, 2012

(54) ELEVATOR SYSTEM

(75) Inventors: Yoshimasa Koba, Tokyo (JP); Naohiko Suzuki, Tokyo (JP)

(73) Assignee: Mitsubishi Electric Corporation, Tokyo (JP)

(21) Appl. No.: 13/496,048

(22) PCT Filed: Dec. 3, 2009
(86) PCT No.: PCT/JP09/70342

§ 371 Date: Mar. 14, 2012

(51) Int. Cl. B66B 1/00

(52) U.S. Cl. 187/247

(57) ABSTRACT

In an elevator system which performs group control of plural elevators, a hall call registration device allows a user to perform registration of a hall call before arriving at an elevator hall, and an assigned car is determined for a remote hall call registered from this hall call registration device. When a remote hall call is registered, measurement of a first time is started, and in the period from the stop of the assigned car at the hall to an elapse of the first time, a door close button of the assigned car is made ineffective. After that, when the first time has elapsed, the door close button is made effective. The assigned car is caused to wait with its door open at the hall until the second time elapses after arrival of the assigned car at the hall or an elapse of the first time, whichever is later.

### TECHNICAL FIELD

The present invention relates to an elevator system which enables a user to register his or her hall call in a place away from an elevator hall.

### BACKGROUND ART

In a building and the like where many people use elevators, a plurality of elevators are installed in the same building and group control of these plurality of elevators is performed in order to increase the operational efficiency as a whole. That is, in the above-described group control, when a hall call is registered by a user, an optimum car is assigned from the above-described plurality of elevators to the registered hall call, thereby responding to the call.

In some of such elevator systems, a device for registering hall calls is installed in a place away from an elevator hall. In this case, time is necessary to some extent before a user arrives at the elevator hall after operating the hall call registration device.

In view of such a situation, as a conventional art of a system having the above-described configuration there have been proposed elevator systems in which car assignment is performed also in consideration of the moving (walking) time to an elevator hall (refer to Patent Literature 1, for example).

Also, as another conventional art, there are elevator systems, such as an elevator system in which a door close operation is started when a user performs personal authentication in a car waiting with door open in an elevator hall (refer to Patent Literature 2, for example) and an elevator system in which the door open time in an elevator hall is determined also in consideration of the time spent until an assigned car arrives at the elevator hall after the registration of a hall call (refer to Patent Literature 3, for example).

### CITATION LIST

### Patent Literature

Patent Literature 1: Japanese Patent Laid-Open No. 60-19673
Patent Literature 2: Japanese Patent Laid-Open No. 2005-324889
Patent Literature 3: Japanese Patent Laid-Open No. 2002-220177

### SUMMARY OF INVENTION

### Technical Problem

In conventional elevator systems in which a hall call registration device is installed in a remote place, including those described in Patent Literature 1 to Patent Literature 3, users sometimes become late for a car for various reasons.

For example, when a user becomes late for some reason and it takes time for the user to move from the position of the hall call registration device to an elevator hall, the door close operation of an assigned car is started before the user arrives at the elevator hall, with the result that the assigned car sometimes takes its departure to another floor.

When the same car is assigned to hall calls registered by a plurality of users, a user who has registered a hall call earlier may sometimes press a door close button in the car or performs personal authentication (in the case of Patent Literature 2), thereby starting a door close operation. In this case, users who have registered hall calls later cannot board the assigned car, with the result that they have to register new hall calls in the elevator hall.

The present invention was made to solve the problems described above, and an object of the invention is to provide an elevator system capable of positively preventing users from being late for a car even in the case where a hall call registration device is installed in a position away from an elevator hall.

### Solution to Problem

An elevator system of the invention is an elevator system which performs group control of a plurality of elevators. The elevator system comprises a hall call registration device by use of which a user performs a prescribed operation before arriving at an elevator hall, call detection means which detects the prescribed operation to the hall call registration device and registers a hall call, assigned car determination means which determines an assigned car corresponding to the hall call registered by the call detection means from cars of the plurality of elevators, operation control means which causes the assigned car determined by the assigned car determination means to stop at the elevator hall and causes the door of the assigned car to open, first determination means which detects that a prescribed first time has elapsed after the hall call is registered, a door close button provided in the assigned car, door close button control means which makes a door close function by the door close button ineffective for a duration from the stop of the assigned car at the elevator hall to the detection of an elapse of the first time by the first determination means, and makes the door close function effective when the elapse of the first time is detected by the first determination means, and second determination means which detects that a prescribed second time has elapsed since the arrival of the assigned car at the elevator hall or the time at which an elapse of the first time is detected by the first determination means, whichever is later. The operation control means causes the assigned car to be waiting with door open in the elevator hall until an elapse of the second time is detected by the second determination means after the stop of the assigned car at the elevator hall.

### Advantageous Effect of Invention

According to the present invention, it becomes possible to positively prevent users from being late for a car in an elevator system in which a hall call registration device is installed in a position away from an elevator hall.

### BRIEF DESCRIPTION OF DRAWINGS

FIG. 1 is a block diagram showing an elevator system in a first embodiment according to the present invention.

FIG. 2 is a flowchart showing the actions of the elevator system in the first embodiment according to the present invention.

### Description of Embodiments

The present invention will be described in more detail with reference to the accompanying drawings. Incidentally, in each of the drawings, like numerals refer to like or corresponding parts and redundant descriptions of these parts are appropriately simplified or omitted.

### First Embodiment

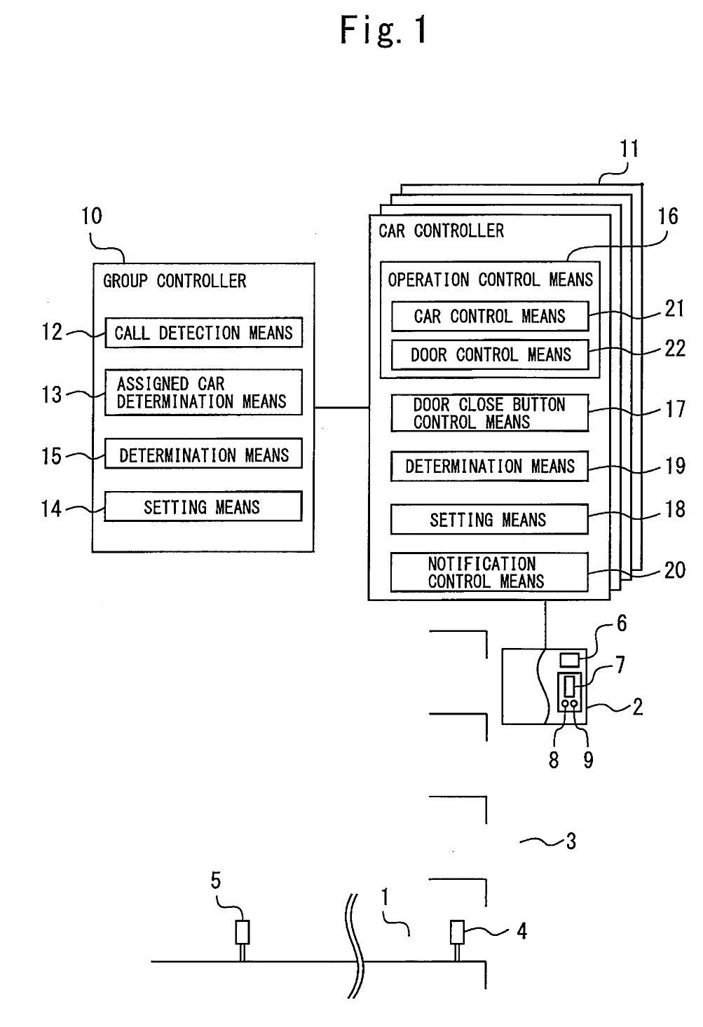

FIG. 1 is a block diagram showing an elevator system in a first embodiment according to the present invention. This elevator system has the function of performing the group control of a plurality of elevators. Incidentally, in FIG. 1, the details of one of the plurality of elevators are shown and the descriptions of other elevators are omitted.

In FIG. 1, reference numeral 1 denotes an elevator hall (hereinafter also referred to simply as “hall”), reference numeral 2 denotes the car of an elevator which ascends and descends in a shaft 3, and reference numerals 4 and 5 denote hall buttons which a user presses in order to register a hall call.

The car 2 is provided, in the interior thereof, with an indicator 6, a car button 7, a door open button 8, a door close button 9 and the like. The indicator 6 comprises a liquid crystal display and the like, and indicates prescribed information to the users in the car 2. Incidentally, this indicator 6 is an example of a notification device which provides notification to the users in the car 2, and other kinds of notification devices, such as announcement equipment, may be installed in the interior of the car 2.

The car button 7 is intended for allowing a user to input a destination floor, the door open button 8 is intended for causing a door open operation to be performed when the car 2 stops, and the door close button 9 is intended for causing a door close action to be performed when the door is opened. All these are installed in the car 2.

The hall button 4 is intended for allowing a user to resister his or her hall call in the hall 1, and installed in a prescribed position of the hall 1. Incidentally, when the hall button 4 is pressed by a user, the pressing information is outputted from the hall button 4 to a group controller 10, which will be described later.

The hall button 5 is intended for a user to register a hall call before arriving at the hall 1, and is installed in a prescribed place away from the hall 1. Incidentally, when the hall button 5 is pressed by a user, the pressing information is outputted from the hall button 5 to a group controller 10.

The above-described hall buttons 4 and 5 are an example of a hall call registration device for registering hall calls, and a hall call registration device in which other operation methods, such as an operation method for using touch panel and an operation method for using card reader, are adopted may be installed in each of the above-described positions. In this case, in registering a hall call, a user performs a prescribed operation for the hall call registration device.

The group controller 10 has the function of group-controlling the plurality of elevators installed in the same building or the like, and a car controller 11 has the function of controlling the operation of each elevator. Specifically, the group controller 10 registers a hall call on the basis of the pressing information from the hall buttons 4 and 5, and assigns an optimum car 2 to the registered hall call. The car controller 11 performs an appropriate response to the registered call on the basis of an assignment instruction from the group controller 10.

The group controller 10 and the car controller 11 perform special control for preventing a user who has pressed the hall button 5 from being late for a car.

In order to realize each of these functions, the group controller 10 is provided with call detection means 12, assigned car determination means 13, setting means 14 and determination means 15.

The call detection means 12 has the function of detecting a prescribed operation for the hall call registration device and registering hall calls. That is, when pressing information is inputted from the hall buttons 4 and 5, the call detection means 12 registers a hall call corresponding to the pressed hall button 4 or 5. In the following description, when discrimination is made between a hall call registered from the hall button 4 and a hall call registered from the hall button 5, the hall call registered by pressing the hall button 4 is called a normal hall call, and the hall call registered by pressing the hall button 5 is called a remote hall call.

The assigned car determination means 13 has the function of determining assigned cars for a normal hall call and a remote hall call, which are registered by the call detection means 12, from the cars 2 of the elevators group-controlled by the group controller 10. Incidentally, when a remote hall call has been registered, the assigned car determination means 13 determines an assigned car also in consideration of the distance from the hall button 5 to the hall 1 (the time required by the movement from the hall button 5 to the hall 1).

The setting means 14 has the function of setting a prescribed first time. This first time corresponds to the time which elapses in the period from the pressing of the hall button 5 by a user to the boarding of the assigned car. For example, the first time is set on the basis of the walking time from the hall button 5 to the hall 1 (or the time obtained by adding a prescribed additional time to this walking time).

The determination means 15 has the function of detecting that the above-described first time has elapsed since the registration of a remote hall call. Specifically, the determination means 15 starts the measurement of the elapsed time when a remote hall call is registered by the call detection means 12. Then, the determination means 15 makes a comparison between the measuring time and the first time, and outputs first elapse information to the car controller 11 of the car 2 to which the remote hall call has been assigned when the determination means 15 determines that the above-described first time has elapsed since the registration of the remote hall call.

On the other hand, the car controller 11 is provided with operation control means 16, door close button control means 17, setting means 18, determination means 19, and notification control means 20.

The operation control means 16 has the function of appropriately controlling a corresponding elevator on the basis of an assignment instruction from the group controller 10. Specifically, when the car 2 of the elevator in question is assigned to a hall call by the assigned car determination means 13 and an assignment instruction is inputted from the group controller 10, the operation control means 16 causes the car 2 to run to the hall 1 of the floor where the hall call has been registered, and causes the car 2 to stop at the hall 1. When the operation control means 16 has caused the car 2 to stop at the hall 1, the operation control means 16 starts a door open operation and causes the car 2 to be waiting with door open in the hall 1 until a new instruction is inputted. Incidentally, this operation control means 16 is provided with car control means 21 which performs the ascent and descent control of the car 2 and door control means 22 which performs the door open and close control.

The door close button control means 17 has the function of switching the condition of the door close button 9 (or an operation for the door close button 9) between an effective condition and an ineffective condition. That is, when the door close function of the door close button 9 has been set ineffective by the door close button control means 17, the door close operation is not started even when a user presses the door close button 9 in the car 2. On the other hand, when the door close function of the door close button 9 has been set effective by the door close button control means 17, the door close operation is started by the pressing of the door close button 9 by the user in the car 2 if other conditions for performing the door close operation are satisfied.

On the other hand, when the car 2 of the elevator in question is assigned to a remote hall call, the door close button control means 17 sets the door close function of the door close button 9 ineffective in the period from a response to the remote hall call to the input of the above-described first elapse information. That is, when the car 2 responds to a remote hall call and stops at the hall 1 before an elapse of the first time, the door close operation is not started until an elapse of the first time is detected by the determination means 15 even when a user presses the door close button 9. When an elapse of the first time is detected by the determination means 15 and the first elapse information is inputted, the door close button control means 17 sets the above-described door close function effective and permits the door close operation by the door close button 9.

The setting means 18 has the function of setting a prescribed second time. This second time corresponds to the period of time in which when the car 2 responds to a remote hall call and stops at the hall 1, the car 2 is caused to be waiting with door open, with the door close function by the door close button 9 kept effective. The second time is set as a given time, for example.

The determination means 19 has the function of detecting that the above-described second time has elapsed since the arrival of the car 2 at the elevator hall 1 in response to a remote hall call or the time at which an elapse of the first time is detected by the determination means 15, whichever is later. Specifically, the determination means 19 starts the measurement of the elapsed time at the time of the arrival of the car 2 at the hall 1 or the time when the first elapse information is inputted, whichever is later. Then, the determination means 19 makes a comparison between the measuring time and the second time and outputs the second elapse information to the operation control means 16 when the determination means 19 determines that the second time has elapsed since the above-described later time.

Incidentally, the operation control means 16 performs control so that the car 2 is waiting with door open in the hall 1 until an elapse of the second time is detected by the determination means 19 since the stop of the car 2 at the hall 1 in response to a remote hall call. Also, after the input of the first elapse information from the group controller 10 during the above-described waiting with door open, the operation control means 16 starts a door close operation when the door close button 9 is pressed and when the second elapse information is inputted from the determination means 19.

The notification control means 20 has the function of controlling the notification device provided in the car 2 (in this embodiment, the indicator 6).

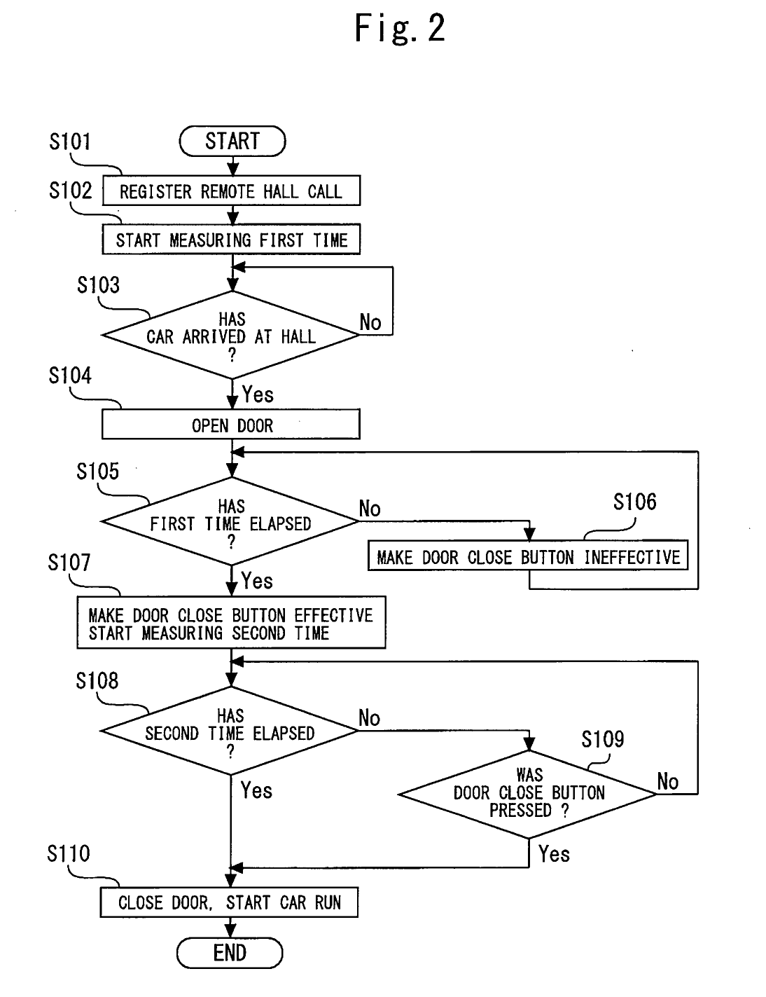

Next, also referring to FIG. 2, a concrete description will be given of the actions of the elevator system having the above-described configuration. FIG. 2 is a flowchart showing the actions of the elevator system in the first embodiment according to the present invention.

When a user presses the hall button 5 during movement to the elevator hall 1, the pressing information is inputted to the group controller 10, and a remote hall call is registered by the call detection means 12 (S101). Also, the group controller 10 starts the measurement of the first time by the input of the above-described pressing information (S102).

When a remote hall call is registered, the group controller 10 performs the selection of an assigned car through the use of the assigned car determination means 13 and outputs an assignment instruction to a corresponding car controller 11. The car controller 11 which received the assignment instruction causes the car 2 to respond to the remote hall call registered in S101. Specifically, the car controller 11 causes the operation control means 16 to stop the car 2 at the hall 1 and causes a door open operation to be performed (S103, S104).

After the arrival of the car 2 at the hall 1, the car controller 11 makes a determination as to whether or not the first time has elapsed (S105). If the car controller 11 did not receive the first elapse information from the group controller 10 in S105, the car controller 11 causes the door close button control means 17 to make the door close button 9 ineffective, thereby prohibiting the door close operation when the door close button 9 is pressed.

Also upon receipt of the first elapse information from the group controller 10 (Yes in S105), the car controller 11 causes the door close button control means 17 to make the door close button 9 of the car 2 effective, thereby permitting the door close operation when the door close button 9 is pressed. Furthermore, the car controller 11 starts the measurement of the second time by receiving the first elapse information from the group controller 10 (S107).

After the processing in S107, the car controller 11 makes a determination as to whether or not the second time has elapsed (S108). Unless the second time elapsed in S108, the car controller 11 makes a determination as to whether or not the door close button 9 has been pressed (S109). When the door close button 9 has been pressed before the second time has elapsed (Yes in S109), or when the second time has elapsed (Yes in S108), the car controller 11 starts the door close operation through the use of the operation control means 16, and thereafter causes the car 2 to run toward the destination floor (S110).

According to the first embodiment of the present invention, in an elevator system in which a hall call registration device is installed in a place away from an elevator hall 1, it becomes possible to positively prevent users from being late for a car with a simple configuration.

That is, in this elevator system, when a remote hall call has been registered, the assigned car is waiting with door open in the hall 1 until at least both the first time and the second time elapse. For this reason, for example, if the second time is set as a time which is long to some extent, a user can positively board the assigned car even when the user arrives late at the hall 1. Incidentally even in the case where the second time is set somewhat long, the door close function by the door close button 9 becomes effective if the first time elapses and, therefore, there is no danger of problems, such as worsened operational efficiency, occurring.

In the case where the same car 2 has been assigned to a plurality of remote hall calls registered from the hall button 5, the door close operation is not started, if this is before an elapse of the first time, even when the user who boarded the car earlier presses the door close button 9 in the car 2. For this reason, there is no possibility that the car 2 takes its departure before users who registered remote hall calls later arrive at the hall 1, and the assigned car can take its departure, with all users boarded therein.

Incidentally, in the case where the same car has been selected for a plurality of remote hall calls, the setting means 14 sets the first time so that all the users who are to board the assigned car can board the car. In this case, it is possible to adopt a method which involves setting a given time beforehand as the first time and carrying out the measurement of the first time from the beginning (that is, resetting the measurement of the first time) each time a remote hall call is registered. That is, the determination means 15 makes a determination as to whether or not the first time has elapsed on the basis of the remote hall call registered last among the plurality of remote hall calls.

The configuration may be such that a plurality of times are set as the first time and the second time, and it is possible to adopt a configuration in which the setting means 14 and 18 can select (or computing and the like) an appropriate time according to the kinds of registered remote hall calls.

In this case, for example, a button for the physically disabled (input means) in the hall call registration device and the like, whereby in registering a remote hall call, a user can input information that the user is physically disabled by pressing the button for the physically disabled. When the above-described button for the physically disabled is pressed, by the setting means 14 and 18, the first time and the second time are set as a time longer than when the button for the physically disabled is not pressed in order to ensure that the door open time in the hall 1 is longer than in normal times. Incidentally, in this control performed when the button for the physically disabled is pressed, it is possible to make only either the first time or the second time longer than in normal times.

Though not mentioned in the above description, when a remote hall call has been registered, it is possible to provide notification suited to the situation from the notification device.

For example during the process from S106 to S107 in FIG. 2, the door close function by the door close button 9 is made ineffective by the door close button control means 17 and the door close operation is not started even when a user presses the door close button 9. For this reason, during the period from the stop of the car 2 at the hall 1 in response to a remote hall call to the detection of an elapse of the first time by the determination means 15, it is possible for the notification control means 20 to cause the notification device to provide notification to the effect that other passengers are being waited for when the door close button 9 is pressed. For example, when the door close button 9 is pressed in the above-described period, the notification control means 20 causes the indicator 6 to indicate the contents that “please, wait for a while,” and the users in the car 2 are informed that there are still other users.

After the car 2 stops at the hall 1 in response to a remote hall call, upon detection of an elapse of the first time by the determination means 15, the notification control means 20 may cause the notification device to provide notification to the effect that the first time has elapsed. For example, when the first elapse information is inputted during the stop of the car 2, the notification control means 20 causes the indicator 6 to indicate the contents that “we will start soon.”

Incidentally, it is also possible to adopt a configuration in which by installing other notification device in the hall 1 or in a prescribed position between the hall button 5 and the hall 1, notification is provided from this notification device when the first time has elapsed and attention is paid to users who may be late for an assigned car.

### INDUSTRIAL APPLICABILITY

The elevator system of the present invention can be applied to elevator systems which group-control a plurality of elevators and in which a hall call registration device is installed in a place away from an elevator hall.

### REFERENCE SIGNS LIST

1 elevator hall
2 car
3 shaft
4, 5 hall button
6 indicator
7 car button
8 door open button
9 door close button
10 group controller
11 car controller
12 call detection means
13 assigned car determination means
14 setting means
15 determination means
16 operation control means
17 door close button control means
18 setting means
19 determination means
20 notification control means
21 car control means
22 door control means

1. An elevator system which performs group control of a plurality of elevators, comprising:
a hall call registration device by use of which a user performs a prescribed operation before arriving at an elevator hall;
a call detection device which detects the prescribed operation to the hall call registration device and registers a hall call;
an assigned car determination device which determines an assigned car corresponding to the hall call registered by the call detection device from cars of the plurality of elevators;
an operation control device which causes the assigned car determined by the assigned car determination device to stop at the elevator hall and causes the door of the assigned car to open;
a first determination device which detects that a prescribed first time has elapsed after the hall call is registered;
a door close button provided in the assigned car;
a door close button control device which makes a door close function by the door close button ineffective for a duration from the stop of the assigned car at the elevator hall to the detection of an elapse of the first time by the first determination device, and makes the door close function effective when the elapse of the first time is detected by the first determination device; and
a second determination device which detects that a prescribed second time has elapsed since the arrival of the assigned car at the elevator hall or the time at which an elapse of the first time is detected by the first determination device, whichever is later,
wherein the operation control device causes the assigned car to be waiting with door open in the elevator hall until an elapse of the second time is detected by the second determination device after the stop of the assigned car at the elevator hall.

2. The elevator system according to claim 1, wherein the operation control device causes the door close operation of the assigned car to start after the detection of an elapse of the first time by the first determination device in the case where the door close button is pressed and the case where an elapse of the second time is detected by the second determination device.

3. The elevator system according to claim 1, wherein in the case where the same car is assigned to a plurality of hall calls registered by the call detection device, the first determination device detects an elapse of the first time on the basis of the hall call registered last among the plurality of hall calls.

4. The elevator system according to claim 1, further comprising:
a notification device provided in the assigned car; and
a notification control device which causes the notification device to provide notification to the effect that other passengers are to be waited for in the case where the door close button is pressed for the period from the stop of the assigned car at the elevator hall to the detection of an elapse of the first time by the first determination device.

5. The elevator system according to claim 1, further comprising:
a notification device provided in the assigned car; and
a notification control device which causes the notification device to provide notification to the effect that the first time has elapsed in the case where an elapse of the first time is detected by the first determination device after the stop of the assigned car at the elevator hall.

6. The elevator system according to claim 1, further comprising:
a notification device which is provided in a prescribed position between the hall call registration device and the elevator hall or in the elevator hall; and
a notification control device which causes the notification device to provide notification to the effect that the first time has elapsed in the case where an elapse of the first time is detected by the first determination device after the stop of the assigned car at the elevator hall.

7. The elevator system according to claim 1, further comprising:
an input device by use of which, in registering a hall call, a user inputs information to the effect that the user is physically disabled; and
a setting device which, in the case where information to the effect that the user is physically disabled is inputted from the input device, sets at least either the first time or the second time as a prescribed time longer than when the input from the input device does not occur.
